(19) United States
(12) Patent Application Publication
(10) Pub. No.: US 2024/0055685 A1
(43) Pub. Date: Feb. 15, 2024

(54) RECOVERY OF VALUABLE MATERIALS AND GRAPHITE FROM END-OF-LIFE LITHIUM-ION BATTERIES

(71) Applicant: University of Kentucky Research Foundation, Lexington, KY (US)

(72) Inventors: Xin Gao, Lexington, KY (US); Kunlei Liu, Lexington, KY (US); Neng Huang, Lexington, KY (US)

(21) Appl. No.: 18/277,359

(22) PCT Filed: Feb. 7, 2022
(86) PCT No.: PCT/US22/15522

§ 371 Date: Aug. 15, 2023

Related U.S. Application Data
(60) Provisional application No. 63/149,429, filed on Feb. 15, 2021.
(60) Provisional application No. 63/215,744, filed on Jun. 28, 2021.

(51) Int. Cl. H01M 10/54; C22B 26/12; C22B 1/02; C22B 7/00

(52) U.S. Cl. CPC H01M 10/54; C22B 26/12; C22B 1/02; C22B 7/005

(57) ABSTRACT

A method of recovering valuable materials from a black mass of lithium ion batteries may be broadly described as including the steps of decomposing the black mass to produce a reduced black mass, extracting lithium from the reduced black mass and separating and recovering magnetic alloy materials and non-magnetic materials from the reduced black mass. An apparatus for recovering valuable materials from a black mass of lithium ion batteries includes a thermal reactor, a stirring reactor, a solid-liquid separator, an oven and a magnet-assisted vibration device.

### RELATED APPLICATIONS

This application claims priority to U.S. Provisional Patent Application Ser. No. 63/149,429 filed on 15 Feb. 2021 and U.S. Provisional Patent Application Ser. No. 63/215,744 filed on 28 Jun. 2021, both of which are hereby incorporated by reference in their entirety.

### TECHNICAL FIELD

This document relates generally to the recovery or enrichment of valuable materials from recycled batteries and, more particularly to the recovery of valuable materials, including lithium, nickel, cobalt manganese, copper and aluminum as well as other metals and graphite from end-of-life or manufactured defect lithium-ion batteries.

### BACKGROUND

As the production of electric vehicles (EVs) and portable electronic devices continues growing, the production of lithium-ion (Li-ion) batteries is expected to surge. According to the global EV outlook 2020 from the International Energy Agency, 2.1 million EVs have been sold globally in 2019 with the total stock of 7.2 million EVs, and the year-to-year increase in the EV registration is approximately 40%. Moreover, many power generation plants now utilize renewable power generation coupled with battery energy storage strategies to reduce pollution and achieve a carbon neutral or carbon negative footprint while meeting the electrical grid demand.

As Li-ion batteries are repeatedly charged and discharged, energy storage performance of the batteries gradually degrades toward their end of life. For the sake of sustainability, economic growth, and environment protection, end-of-life (EOL) Li-ion batteries, as well as manufactured defect batteries, are needed to be recycled while recovering valuable materials for reuse or other beneficial uses. For instance, cobalt (Co), an essential chemical from the Li-ion battery's cathode, is needed to be recovered since Co has been extensively used in alloys, catalysts, oxygen carriers, sensors, radars, pigments and the like and it is in limited supply. Furthermore, the USGS predicts that Co will be deficient globally to meet the production volume of Li-ion batteries in the coming decade. Additionally, efforts made to recover cobalt and other metals from the spent Li-ion batteries are, in many instances, more eco-friendly and convenient compared to the cobalt mining processes.

This document discloses a separation method or process that efficiently and effectively recovers the valuable metals, lithium salts and graphite from the black mass of end-of-life Li-ion batteries. Advantageously, this is accomplished without using strong inorganic and/or organic acids or reducing agents, differing significantly from the methods disclosed in the contemporary patents and literature. Moreover, the graphite is also recovered from the black mass. As a result, carbon emissions from the process are also avoided or minimized.

### SUMMARY

In accordance with current practices, end-of-life lithium-ion batteries are collected, dismantled and shredded. That shredded material is then processed in a manner known in the art to produce what is referred to in the industry and this document as “black mass”. The composition of the black mass varies, depending upon the battery chemistry used by the battery manufacturer. In addition to lithium, the black mass often also includes cobalt, nickel, manganese, copper, aluminum, graphite and other valuable materials.

In accordance with the purposes and benefits described herein, a new and improved method is provided for recovering the valuable materials from the black mass of end-of-life lithium ion batteries. That method may be broadly described as comprising, consisting of or consisting essentially of the steps of: (a) decomposing the black mass to produce a reduced black mass, (b) extracting lithium from the reduced black mass and (c) separating and recovering magnetic alloy materials (e.g. cobalt, nickel, manganese) and non-magnetic materials (e.g. graphite, copper, aluminum) from the reduced black mass.

In one or more of the many possible embodiments of the method, the decomposing of the black mass includes subjecting the black mass to thermal reduction. More specifically, the thermal reduction includes heating the black mass to a temperature of between about 500° C. and about 1,000° C. in the presence of a reducing agent in the reducing atmosphere.

The reducing agent may be selected from a group of reducing agents, consisting of (a) a reducing gas, such as hydrogen gas, carbon monoxide gas and/or methane gas, (b) carbon-based solids, such as graphite solids, contained in and/or added to the black mass, (c) aluminum solids, contained in or added to the black mass, (d) plastic separator solids, contained in and/or added to the black mass and (e) mixtures thereof. Where a reducing gas is used, the thermal reduction of the black mass may be performed in a reducing atmosphere including the reducing gas and an inert gas at a mixture ratio of the reducing gas to total gas of about 0.001-0.2 in volume basis. Where a reducing carbon-based solid, such as graphite, aluminum and/or plastic separator is present, the thermal reduction of the black mass may be performed in a reducing atmosphere including the reducing solid and an inert gas at a flowrate to maintain appropriate gaseous atmosphere. The inert gas used in the method may be, for example, argon, nitrogen or a combination of argon and nitrogen.

In one or more of the many possible embodiments of the method, the step of extracting the lithium may include the steps of: (a) mixing the reduced black mass with water whereby lithium oxide, lithium carbonate or lithium oxide and lithium carbonate in the reduced black mass interacts with the water to produce water soluble lithium salts, (b) separating the water and water soluble lithium salts from a reduced black mass residual and (c) evaporating the separated water to recover lithium in the lithium salts.

In one or more of the many possible embodiments of the method, the step of separating and recovering the magnetic materials and non-magnetic materials may include the steps of; (a) drying the reduced black mass residual following separation from the water and water soluble lithium hydroxide and (b) using a magnet to separate the magnetic alloy materials from the non-magnetic materials including any graphite, copper and aluminum in the reduced black mass residual. In at least one of the many possible embodiments of the method, the method includes separating and recovering of the magnetic alloy materials and non-magnetic materials by using a magnet-assisted vibration device.

In accordance with yet another aspect, a method for recovering valuable materials from a black mass of processed, end-of-life lithium ion batteries, comprises, consists of or consists essentially of the steps of: (a) delivering the black mass into a thermal reactor, (b) heating the black mass to a temperature of between about 500° C. and about 1,000° C. in the presence of a reducing agent in the thermal reactor to produce a reduced black mass with inert gas as a carry gas to maintain the reaction atmosphere, (c) delivering the reduced black mass and water to a solid-liquid mixer wherein lithium oxide and lithium carbonate in the reduced black mass interacts with the water to become water soluble lithium salts, (d) separating the water and water soluble lithium salts from the reduced black mass in a solid-liquid separator, (e) evaporating the separated water and water soluble lithium salts to recover the lithium salts, (0 drying the separated reduced black mass residual in an oven to produce a dried solid and (g) delivering the dried solid to a magnet-assisted vibration device to separate magnetic alloy materials in the dried solid from non-magnetic materials in the dried solid.

In at least one of the many possible embodiments of this method, the reducing agent is selected from a group of reducing agents, consisting of (a) a reducing gas, such as hydrogen gas, carbon monoxide gas, and/or methane gas, (b) carbon-based solids, such as graphite solids, contained in and/or added to the black mass, (c) aluminum solids, contained in and/or added to the black mass, (d) plastic separator solids, contained in and/or added to the black mass and (e) mixtures thereof. Where a reducing gas is used, the thermal reduction of the black mass may be performed in a reducing atmosphere including the reducing gas and an inert gas at a mixture ratio of the reducing gas to total gas of about 0.001-0.2 in volume basis. Where a reducing carbon-based solid, such as graphite, aluminum, and/or plastic separator, is present, the thermal reaction of the black mass may be performed in a reducing atmosphere including the reducing solid and an inert gas at a flowrate to maintain appropriate gaseous atmosphere. The inert gas used in the method may be, for example, argon, nitrogen or a combination of argon and nitrogen.

In one or more of the many possible embodiments, the mass ratio of water to solids in the stirring reactor is greater than 1:1.

In accordance with still another aspect, an apparatus is provided for recovering valuable materials from the black mass of processed, end-of-life lithium ion batteries. That apparatus comprises, consists of or consists essentially of: (a) a thermal reactor adapted for receiving the black mass and thermally reducing the black mass to a reduced black mass, (b) a solid-liquid mixer downstream from the thermal reactor and adapted for receiving the reduced black mass and water from the thermal reactor, (c) a solid-liquid separator downstream from the solid-liquid mixer and adapted for receiving the water and the reduced black mass from the solid-liquid mixer and separating the liquid from the reduced black mass, (d) an oven downstream from the solid-liquid separator and adapted for drying the reduced black mass residual received from the solid-liquid separator and (e) a magnet-assisted vibration device downstream from the oven and adapted to receive the dried reduced black mass residual from the oven and separate magnetic alloy materials in the reduced black mass residual from non-magnetic materials in the reduced black mass residual.

In one or more of the many possible embodiments of the apparatus, the apparatus further includes a water supply source connected to the solid-liquid mixer. In one or more of the many possible embodiments of the apparatus, the apparatus further includes a source of reducing agent connected to the thermal reactor.

In the following description, there are shown and described several preferred embodiments of the method and apparatus for recovering valuable materials from the black mass of processed lithium ion batteries. As it should be realized, the method and apparatus are capable of other, different embodiments and their several details are capable of modification in various, obvious aspects all without departing from the method and apparatus as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the method and apparatus for recovering valuable materials from the black mass of processed lithium ion batteries and together with the description serve to explain certain principles thereof.

FIG. 1 is a schematic illustration of the new and improved method and apparatus for recovering valuable materials from the black mass of processed, end-of-life lithium ion batteries.

FIG. 2 illustrates XRD patterns and metal contents associated with Case 1 of the Experimental Section.

FIG. 3 illustrates XRD patterns and metal contents associated with Case 2 of the Experimental Section.

FIG. 4 illustrates XRD patterns associated with Case 3 of the Experimental Section.

FIG. 5 illustrates XRD patterns associated with Case 4 of the Experimental Section. Top plot: black mass, middle plot; reduction at 600° C. using graphite with 100 Vol % nitrogen, and bottom plot: reduction at 600° C. using 10 Vol % hydrogen mixed with 90 Vol % nitrogen.

FIG. 6 illustrates XRD patterns associated with Case 5 of the Experimental Section. Top plot: black mass, middle plot; reduction at 600° C. using graphite with 100 Vol % nitrogen for 15 minutes, and bottom plot: reduction at 600° C. using 20 Vol % hydrogen mixed with 80 Vol % nitrogen for 15 minutes.

FIG. 7 illustrates XRD patterns associated with Case 6 of the Experimental Section.

Reference will now be made in detail to the present preferred embodiments of the method and apparatus for recovering valuable materials from the black mass of processed lithium ion batteries, examples of which are illustrated in the accompanying drawing figures.

### DETAILED DESCRIPTION

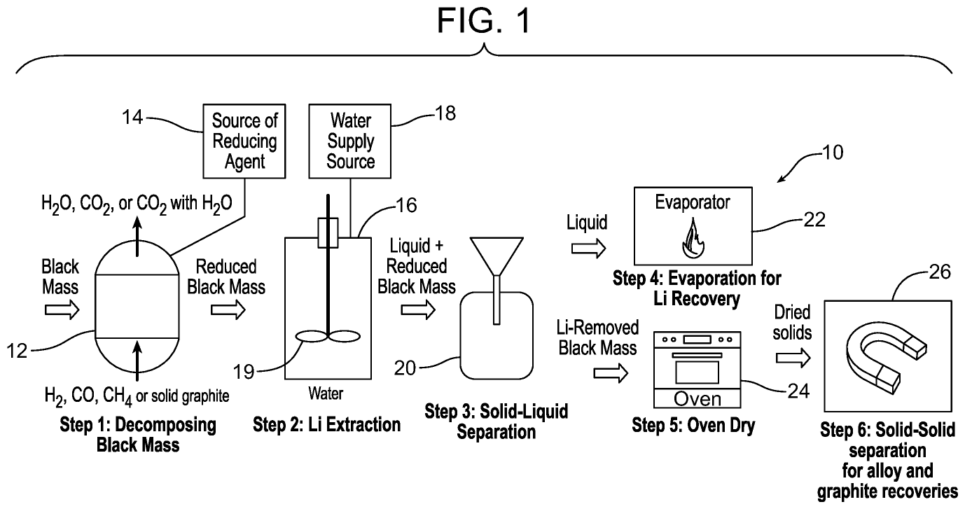

FIG. 1 schematically illustrates the new apparatus and method of recovering valuable materials from a black mass of processed lithium ion batteries. Those valuable materials include, but are not necessarily limited to nickel (Ni), cobalt (Co), lithium (Li), manganese (Mn), and copper (Cu) from the black mass of the processed, end-of-life Li-ion batteries, but generally in three categories such as magnetic, water soluble and residual. The black mass often includes one of the active solid materials from the cathode (e.g., LiCoO₂, LiNi_{0.8}Co_{0.15}Al_{0.05}O₂(NCA), LiNiₓMn_{y}Co_{z}O₂ (NMC where x+y+z=1), or LiFePO₄ (LFP), depending on the type of Li-ion batteries), graphite from the anode, copper from the anode, aluminum from the cathode, and trace plastic from the separator.

The apparatus 10 may be generally described as including a thermal reactor 12 that is adapted for receiving the black mass and thermally reducing the black mass to a reduced black mass. The thermal reactor 12 may be a moving bed reactor (e.g. a moving bed reactor, a fluidized bed reactor or rotary reactor) or a fixed bed reactor under a reducing environment as described below.

A source of reducing agent 14 may be connected to the thermal reactor 12 and adapted for delivering a reducing agent and atmosphere to support the reduction of the black mass in the thermal reactor as further described in the method description below.

A solid-liquid mixer, such as stirring reactor 16, is provided downstream from the thermal reactor 12. The solid-liquid mixer/stirring reactor 16 is adapted for receiving the reduced black mass from the thermal reactor 12 and water from a water supply source 18. An agitator 19 functions to agitate the water and reduced black mass mixture.

A solid-liquid separator 20, of a type known in the art, is provided downstream from the solid-liquid mixer/stirring reactor 16. The solid-liquid separator 20 is adapted for (a) receiving the liquid and the reduced black mass residual from the solid-liquid mixer/stirring reactor 16 and (b) separating the liquid from the reduced black mass residual.

An evaporator 22 receives the separated liquid from the solid-liquid separator 20. The evaporator 22 functions to evaporate the water and recover lithium salts as described in greater detail below.

An oven 24 is provided downstream from the solid-liquid separator 20. The oven 24 is adapted for receiving and drying the reduced black mass residual received from the solid-liquid separator 20.

A magnet-assisted vibration device 26 is provided downstream from the oven 24. The magnet-assisted vibration device 26 is adapted to (i) receive the dried reduced black mass residual from the oven 24 and (ii) separate magnetic alloy materials in the now dried solid from non-magnetic materials in the dried solid. The magnet-assisted vibration device 26 creates a vibration that tends to separate magnetic alloy materials from non-magnetic materials in a manner so that the non-magnetic materials fall away from the magnet and the magnetic materials. The magnet could be a permanent magnet or an electric-induced magnet. For example, the magnet-assisted device 26 may comprise one or more magnets that are continuously struck by one or more hammers or a cam mechanism.

While not illustrated, conveyors of appropriate construction may be used to transfer (a) the black mass starting material from a source thereof (not shown) to the thermal reactor 12, (b) the reduced black mass from the thermal reactor 12 to the solid-liquid mixer/stirring reactor 16, (c) the separated reduced black mass residual from the solid-liquid separator 20 to the oven 24 and (d) the dried reduced black mass residual from the oven 24 to the magnet-assisted vibration device 26. A pump and conduit system may be used to transfer the separated liquid from the solid-liquid separator 20 to the evaporator 22. A vacuum pump or induced draft fan may be provided to extract the gas effluent from the thermal reactor in order to maintain the reduced atmosphere.

The apparatus 10 is useful in a new and improved method of recovering valuable materials from a black mass of processed lithium ion batteries. Advantageously, that recovery of valuable materials including, but not necessarily limited to, lithium, nickel, cobalt, manganese, copper, aluminum and graphite, does not require the addition of any strong inorganic or organic acids. For purposes of this document, “strong inorganic acids” refers to mineral acids, including but not necessarily limited to sulfuric acid, nitric acid, hydrochloric acid.

In some embodiments of the method, the recovery of valuable materials does not require the addition of any reducing agent to the black mass, relying upon the carbon-based solid, such as graphite, aluminum and/or plastic separators already contained in the black mass to serve this function.

The method may be described as including the steps of: (a) decomposing cathode active materials in the black mass to produce a reduced black mass, (b) extracting lithium from the reduced black mass and (c) separating and recovering magnetic alloy materials and non-magnetic materials from the reduced black mass.

More particularly, the decomposing of the cathode active materials in the black mass includes subjecting the black mass to thermal reduction in the thermal reactor 12. The thermal reduction may include heating the black mass in the thermal reactor 12 to a temperature of between about 500° C. and about 1,000° C. in the presence of a reducing agent. The heating may take place for a period of time of between about 5 to 30 minutes. That reducing agent may solely comprise carbon-based solid graphite or plastic separators native to or found in the black mass as delivered to the thermal reactor 12. In some embodiments, additional solid reagent, such as char, may be added. In still other embodiments, a reducing gas, such as hydrogen gas, carbon monoxide gas, methane gas or combinations thereof is delivered to the thermal reactor 12. A combination of carbon-based solid graphite, solid plastic separator and reducing gas may also be used.

Where a reducing gas is delivered to the thermal reactor, a reducing atmosphere may be established in the thermal reactor 12. That reducing atmosphere may include the reducing agent and an inert gas. Inert gases useful for this purpose include, but are not necessarily limited to argon, nitrogen and combinations of argon and nitrogen.

The step of extracting the lithium from the reduced black mass may include the steps of: (a) mixing the reduced black mass with water in the solid-liquid mixer/stirring reactor 16 whereby lithium oxide and/or lithium carbonate in the reduced black mass interacts with the water to produce water soluble lithium salts, (b) separating the liquid, water and water soluble lithium hydroxide from the reduced black mass and (c) evaporating the separated liquid to recover lithium salts. In one useful embodiment, the mass ratio of water to solids in the solid-liquid mixer/stirring reactor 16 is greater than 1:1. The black mass and water mixture in the solid-liquid mixer/stirring reactor 16 may be agitated at a rate of between about 50-500 rpm for a period of time of between about 30 to 60 minutes to ensure proper mixing and dissolving of all lithium compounds. The mixing step was carried out at lab room temperature, 22-25° C. The water used in the mixing was deionized water with a pH of 6-7. After the mixing, the pH of the water was 12-13, suggesting lithium hydroxide and/or lithium carbonate were dissolved into the deionized water.

The step of separating and recovering the magnetic materials and non-magnetic materials may include the steps of: (a) drying the reduced black mass residual in the oven 24 following separation from the water and water soluble lithium hydroxide and (b) using a magnet to separate the magnetic alloy materials, including nickel, cobalt and manganese, from the non-magnetic materials, including any graphite, copper and aluminum, in the dried, reduced black mass residual. This may be done using the magnet-assisted vibration device 26.

Alternatively, the method for recovering valuable materials from a black mass of processed lithium ion batteries may be described as comprising the steps of: (a) delivering the black mass into a thermal reactor 12, (b) heating the black mass to a temperature of between about 600° C. and about 1,000° C. in the presence of a reducing agent in the thermal reactor to produce a reduced black mass, (c) delivering the reduced black mass and water to a solid-liquid mixer/stirring reactor 16 wherein lithium oxide in the reduced black mass reacts with the water to become water soluble lithium hydroxide, (d) separating the liquid, water and water soluble lithium salts from the reduced black mass in a solid liquid separator 20, (e) evaporating, in an evaporator 22 or by other means, the separated liquid, water and water soluble lithium hydroxide to recover lithium, which includes lithium salts and other lithium compounds, (f) drying the separated reduced black mass residual in an oven 24 to produce a dried solids and (g) delivering the dried solids to a magnet-assisted vibration device 26 to separate magnetic alloy materials in the dried solids from non-magnetic materials in the dried solids.

The following Experimental Section further illustrates the method.

Experimental Section

Cases 1-3 Show

The current process can enrich metals and recover graphite from the black mass without using any strong chemicals;

Replacing Ar gas with N₂ gas is feasible to enrich metals and recover graphite from the black mass;

Solid graphite acting as a reducing reagent from the black mass can decompose the active material from the black mass.

Case 1 Using 15 Vol % H₂ Mixed with 85 Vol % Ar at 750° C. for 30 Min

Step 1: 5.52 g of black mass was placed onto a quartz sample boat, in which the black mass contains NCA, graphite, Cu, Al, and trace plastic separator. The sample boat with the black mass was placed into a tube furnace reactor. During the process, 15 Vol % H₂ mixed with 85 Vol % Ar was constantly flashed through the tube reactor at 20 mL min′ for 30 min, in which the H₂ was produced from water electrolysis.

Step 2: After the reactor was cooled to the ambient temperature, the reduced black mass was transferred into an agitation reactor, in which 300 mL of deionized water was mixed with the solids at the agitation rate of 500 rpm for about 60 min. Li was extracted from the reduced black mass into the liquid at this stage.

Steps 3 and 4: All the solids and liquid were transferred to a solid-liquid separator in which lithium hydroxide and/or lithium carbonate liquid was separated using vacuum from the solids containing graphite, magnetic alloy, and Cu. Finally, in this step, the liquid containing lithium salts was heated at 105° C. overnight to recover solid Li(OH) and/or solid Li₂(CO₃).

Steps 5 and 6: The wet solids, the Li removed black mass, were placed into an oven at 105° C. overnight. After drying, the Li removed black mass, was placed into a magnet-assisted separator for solid-solid separation. During the separation, a hammer constantly hit a magnet for about 40 min per 10 gram of solids. Under such a condition, the magnetic alloy was attracted by the magnet while the non-magnetic graphite and Cu fell onto the weighing paper.

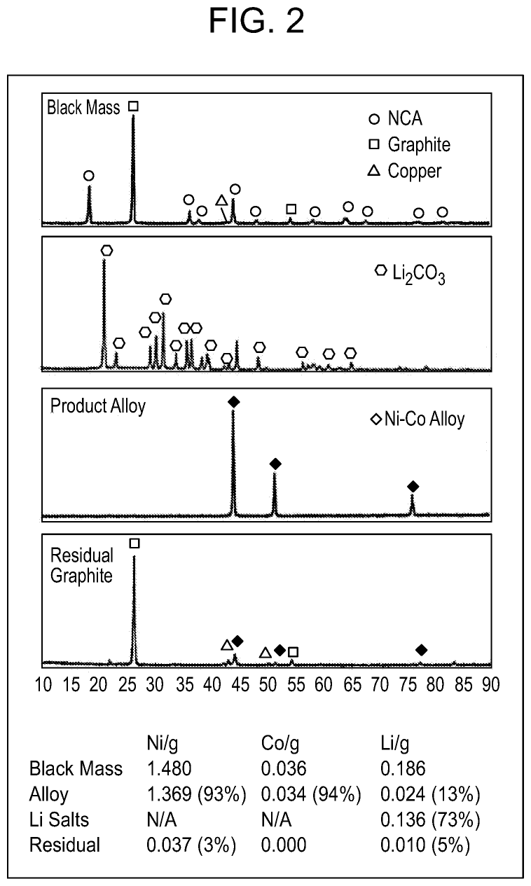

FIG. 2 shows the XRD patterns for the solid products. The top plot shows that the black mass used in Case 1 mainly includes the NCA, graphite, and trace Cu. According to the second plot, the product after Step 4 is mainly composed of Li₂CO₃ via Li(OH) reacting with CO₂ from air. The third plot depict the magnetic alloy has the main phase of Ni with the minor phase of Co. The last plot shows that the residual includes graphite, trace alloy, and trace Cu.

Finally, by using ICP-AMS to measure the Ni, Co, and Li contents for each solid, the table in FIG. 2 shows that, with respect to the starting black mass, 93% Ni and 94% Co have been enriched in the magnetic alloy, and 73% Li has been concentrated in the Li₂CO₃.

Case 2 Using 15 Vol % H₂ Mixed with 85 Vol % N₂ at 750° C. for 30 Min

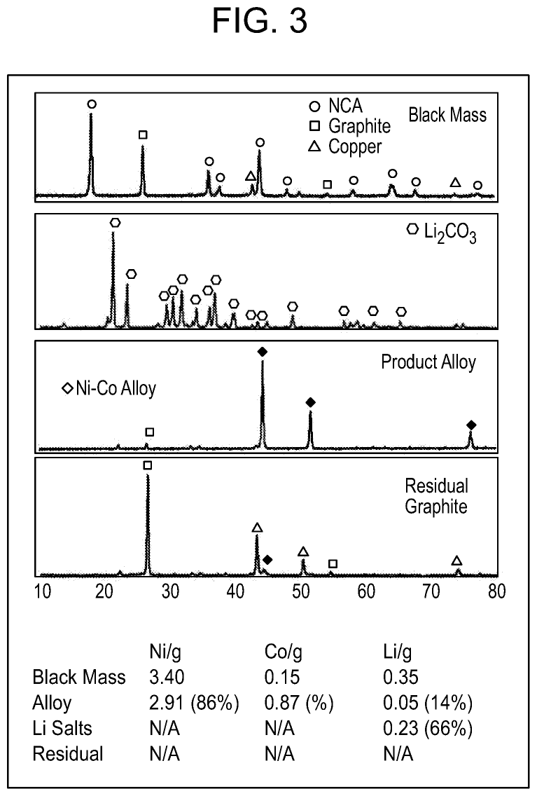

In Case 2, Ar gas was replaced with N₂ gas during Step 1, the decomposition of the black mass. 9.27 g of black mass was placed onto a quartz sample boat, in which the black mass contains NCA, graphite, Cu, Al, and trace plastic by vision. The other conditions, e.g., separation steps, were retained as the same as shown in Case 1. FIG. 3 shows the XRD patterns for the solid products from Case 2. The patterns are very similar with those in FIG. 2, e.g., the magnetic alloy has the main phase of Ni. Thus, it is believed that replacing Ar gas with N₂ gas is feasible to be used in Step 1, the black mass decomposition. The Ni, Co, and Li contents for each solid are depicted in the table in FIG. 3.

Case 3 Using 100 Vol % N₂ at 750° C. for 30 Min

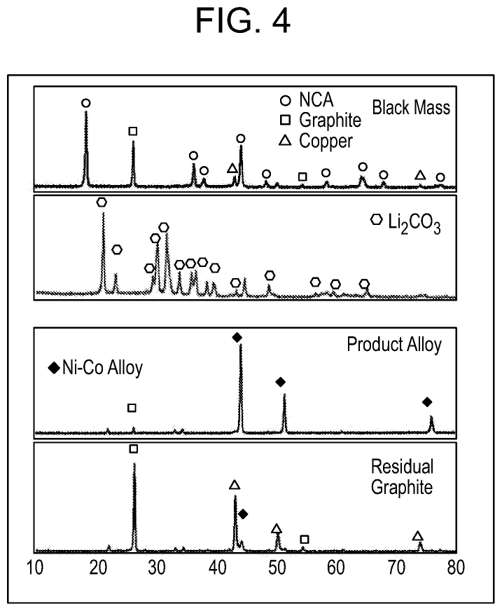

In Case 3, only N₂ gas was used during the decomposition of the black mass, and the reducing environment was provided by solid graphite. (Please note that Cases 1 and 2 were conducted via gas-solid reaction while Case 3 was performed using solid-solid reaction.) 12.70 g of black mass was placed onto a quartz sample boat, in which the black mass contains NCA, graphite, Cu, Al, and trace plastic. FIG. 4 shows the XRD patterns for the solid products after each step in Case 3. These XRD patterns are very similar with those in FIG. 2. Thus, it is believed that no use of H₂ is required in Step 1, the decomposition of the active material, if the black mass natively contains graphite of more than 10 wt %. The graphite is used for the anode of the lithium ion battery. The percentage of graphite in the black mass was about 40-50 wt %.

Cases 4 and 5 Show

If the graphite from the black mass is the primary reducing reagent, the H₂ addition can reduce the processing temperature to produce Ni facilitating the magnet-assisted separation, Step 5.

If the graphite from the black mass is the primary reducing reagent, addition of H₂ can reduce the processing time to produce Ni facilitating the magnet-assisted separation, Step 5.

Case 4 Using Graphite as a Reducing Source at 600° C. for 30 Min with/without H₂

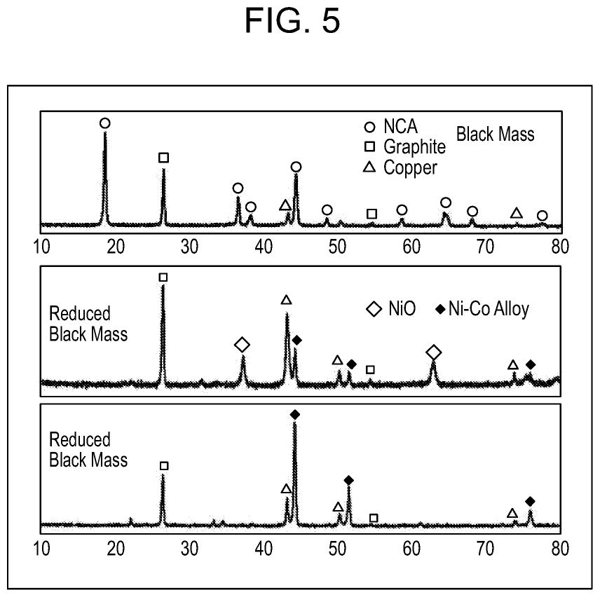

In Case 4, the processing temperature at the Step 1 was reduced to 600° C. for 30 min. In FIG. 5, the reduced black mass, before performing separation of Steps 2-6, shows only use of graphite as a reducing source without H₂ at 600° C. produces NiO in the middle plot, in which NiO solids cannot be easily separated in Step 5, as NiO has the weaker magnetic attraction power in comparison of Ni. When using graphite with 10% H₂ as a reducing source at 600° C., in the bottom plot of FIG. 5, the reduced black mass has the Ni—Co alloy. Since Ni—Co alloy has a strong magnetic attraction force, Step 5, magnet-assisted separation, is feasible to separate Ni—Co alloy from the non-magnetic graphite and Cu.

Case 5 Using Graphite as a Reducing Source at 600° C. for 15 Min with/without H₂

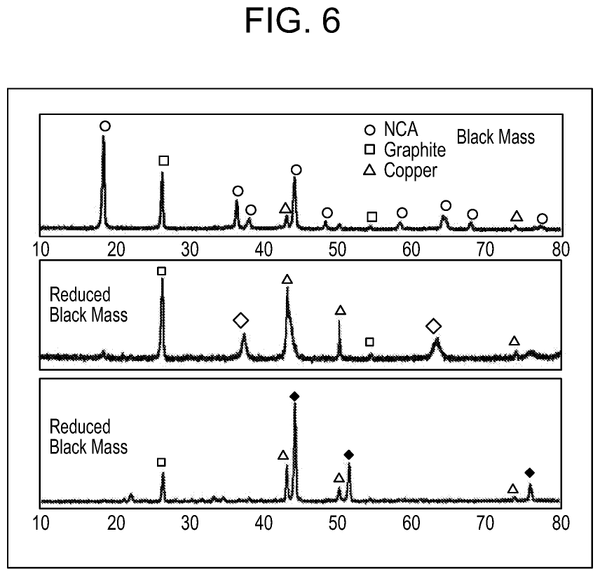

Using H₂ as a reducing aid can reduce the processing time by looking at the XRD comparison in FIG. 6.

Case 6 Shows

Besides NCA-based black mass, the process can also enrich metals and recover graphite from MNC-based black mass.

Case 6 Using Graphite and Trace Aluminum in the Black Mass as a Reducing Source at 750° C. for 30 Min

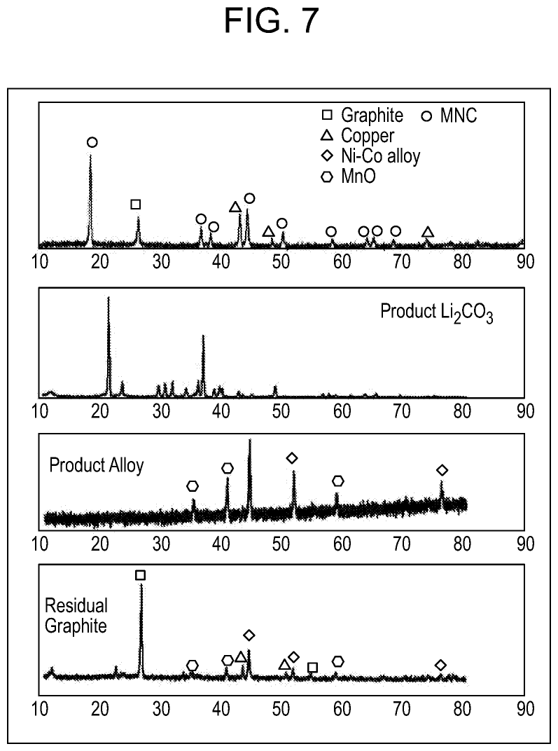

Using the same process as mentioned in Case 3, MNC based black mass was processed to enrich the metals and recover the graphite. FIG. 7 shows the XRD patterns for the solids. It can be seen that (1) the alloy consists of mainly MnO, Ni, and Co from the black mass; (2) Li₂CO₃ is produced; and (3) the residual is composed of graphite and trace of MnO, Ni—Co, and Cu.

This disclosure may be said to relate to the following items.
1. A method of recovering valuable materials from a black mass of processed lithium ion batteries, comprising:
   decomposing the black mass to produce a reduced black mass;
   extracting lithium from the reduced black mass; and
   separating and recovering magnetic alloy materials and non-magnetic materials from the reduced black mass.
2. The method of item 1, wherein the decomposing of the black mass includes subjecting the black mass to thermal reduction.
3. The method of item 2, wherein the thermal reduction includes heating the black mass to a temperature of between about 500° C. and about 1,000° C. in the presence of a reducing agent.
4. The method of item 3, wherein the reducing agent is selected from a group of reducing agents, consisting of a reducing gas, hydrogen gas, carbon monoxide gas, methane gas, carbon-based solids, graphite solids, aluminum solids, plastic separator solids and mixtures thereof
5. The method of item 4, wherein the thermal reduction of the black mass is performed in a reducing atmosphere including (a) the reducing gas and an inert gas wherein a mixture ratio of the reducing gas to total gas is about 0.001-0.2 in volume basis or (b) reduced solids and an inert gas wherein a certain gas flowrate is required to maintain an appropriate reduced atmosphere
6. The method of item 5, further including using argon gas as the inert gas.
7. The method of item 5, further including using nitrogen gas as the inert gas.
8. The method of any of items 1-7, wherein the extracting of the lithium includes:
   mixing the reduced black mass with water whereby lithium oxide, lithium carbonate or lithium oxide and lithium carbonate in the reduced black mass interacts with the water to produce water soluble lithium salts;
   separating the liquid, water and water soluble lithium salts from a reduced black mass residual; and
   evaporating the separated liquid to recover lithium salts.
9. The method of item 8, wherein the separating and recovering of the magnetic materials and non-magnetic materials includes:
   drying the reduced black mass residual following separation from the water and water soluble lithium salts; and
   using a magnet to separate the magnetic alloy materials from non-magnetic materials including any graphite, copper and aluminum in the reduced black mass residual.
10. The method of item 9, wherein the separating and recovering of the magnetic alloy materials and non-magnetic materials is done by using a magnet-assisted vibration device.
11. A method for recovering valuable materials from a black mass of processed lithium ion batteries, comprising:
   delivering the black mass into a thermal reactor;
   heating the black mass to a temperature of between about 500° C. and about 1,000° C. in the presence of a reducing agent in the thermal reactor to produce a reduced black mass;
   delivering the reduced black mass and water to a solid-liquid mixer wherein lithium oxide, lithium carbonate or lithium oxide and lithium carbonate in the reduced black mass reacts with the water to become water soluble lithium salts;
   separating the water and water soluble lithium salts from a reduced black mass residual in a solid-liquid separator;
   evaporating the separated water and water soluble lithium salts to recover lithium;
   drying separated reduced black mass residual in an oven to produce a dried reduced black mass residual; and
   delivering the dried reduced black mass residual to a magnet-assisted vibration device to separate magnetic alloy materials in the dried reduced black mass from non-magnetic materials in the dried reduced black mass.
12. The method of item 11, wherein the reducing agent is selected from a group of reducing agents, consisting of a reducing gas, hydrogen gas, carbon monoxide gas, methane gas, carbon-based solids, graphite solids, aluminum solids, plastic separator solids and mixtures thereof
13. The method of item 12, wherein the thermal reduction of the black mass is performed in a reducing atmosphere including the reducing gas and an inert gas wherein a mixture ratio of the reducing gas to total gas is about 0.001-0.2 in volume basis.
14. The method of any of items 11-13, wherein a mass ratio of water to solids in the stirring reactor is greater than 1:1.
15. An apparatus for recovering valuable materials from a black mass of processed lithium ion batteries, comprising:
   a thermal reactor adapted for receiving the black mass and thermally reducing the black mass to a reduced black mass;
   a solid-liquid mixer downstream from the thermal reactor and adapted for receiving the reduced black mass and water;
   a solid-liquid separator downstream from the solid-liquid mixer and adapted for (a) receiving the liquid and the reduced black mass from the stirring reactor and (b) separating the liquid from a reduced black mass residual;
   an oven downstream from the solid-liquid separator and adapted for receiving and drying the reduced black mass residual received from the solid-liquid separator; and
   a magnet-assisted vibration device downstream from the oven and adapted to (i) receive the reduced black mass residual from the oven and (ii) separate magnetic alloy materials in the reduced black mass residual from non-magnetic materials in the reduced black mass residual.
16. The apparatus of item 15, further including a water supply source connected to the solid-liquid mixer.
17. The apparatus of item 16, further including a source of reducing agent connected to the thermal reactor.

Each of the following terms written in singular grammatical form: “a”, “an”, and the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrases: “a thermal reactor”, and “a step”, as used herein, may also refer to, and encompass, a plurality of thermal reactors and a plurality of steps, respectively.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the method and apparatus for recovering valuable materials from the black mass of processed lithium ion batteries of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A method of recovering valuable materials from a black mass of lithium ion batteries, comprising:
decomposing the black mass to produce a reduced black mass;
extracting lithium from the reduced black mass; and
separating and recovering magnetic alloy materials and non-magnetic materials from the reduced black mass.

2. The method of claim 1, wherein the decomposing of the black mass includes subjecting the black mass to thermal reduction.

3. The method of claim 2, wherein the thermal reduction includes heating the black mass to a temperature of between about 500° C. and about 1,000° C. in the presence of a reducing agent.

4. The method of claim 3, wherein the reducing agent is selected from a group of reducing agents, consisting of a reducing gas, hydrogen gas, carbon monoxide gas, methane gas, carbon-based solids, graphite solids, aluminum solids, plastic separator solids and mixtures thereof.

5. The method of claim 4, wherein the thermal reduction of the black mass is performed in a reducing atmosphere including (a) the reducing gas and an inert gas wherein a mixture ratio of the reducing gas to total gas is about 0.001-0.2 in volume basis or (b) reduced carbon-based solids and an inert gas wherein a certain flow rate is required to maintain an appropriate reduced atmosphere.

6. The method of claim 5, further including using argon as the inert gas.

7. The method of claim 5, further including using nitrogen gas as the inert gas.

8. The method of claim 1, wherein the extracting of the lithium includes:
mixing the reduced black mass with water whereby lithium oxide, lithium carbonate or lithium oxide and lithium carbonate in the reduced black mass reacts with the water to produce water soluble lithium salts;
separating the water and water soluble lithium salts from a reduced black mass residual; and
evaporating the separated water and water soluble lithium salts to recover lithium salts.

9. The method of claim 8, wherein the separating and recovering of the magnetic materials and non-magnetic materials includes:
drying the reduced black mass residual following separation from the water and water soluble lithium salts; and
using a magnet to separate the magnetic alloy materials from non-magnetic materials including any graphite, copper and aluminum in the reduced black mass residual.

10. The method of claim 9, wherein the separating and recovering of the magnetic alloy materials and non-magnetic materials is done by using a magnet-assisted vibration device.

11. A method for recovering valuable materials from a black mass of lithium ion batteries, comprising:
delivering the black mass into a thermal reactor;
heating the black mass to a temperature of between about 500° C. and about 1,000° C. in the presence of a reducing agent in the thermal reactor to produce a reduced black mass;
delivering the reduced black mass and water to a solid-liquid mixer wherein lithium oxide, lithium carbonate or lithium oxide and lithium carbonate in the reduced black mass reacts with the water to become water soluble lithium salts;
separating the water and water soluble lithium salts from a reduced black mass residual in a solid-liquid separator;
evaporating the separated water and water soluble lithium salts to recover lithium;
drying the separated reduced black mass residual in an oven to recover any remaining lithium and produce a dried solids; and
delivering the dried solids to a magnet-assisted vibration device to separate magnetic alloy materials in the dried solids from non-magnetic materials in the dried solids.

12. The method of claim 11, wherein the reducing agent is selected from a group of reducing agents, consisting of a reducing gas, hydrogen gas, carbon monoxide gas, methane gas, carbon-based solids, graphite solids, plastic separator solids and mixtures thereof.

13. The method of claim 12, wherein the thermal reduction of the black mass is performed in a reducing atmosphere including the reducing gas and an inert gas wherein a mixture ratio of the reducing gas to total gas is about 0.001-0.2 in volume basis.

14. The method of claim 11, wherein a mass ratio of water to solids in the stirring reactor is greater than 1:1.

15. An apparatus for recovering valuable materials from a black mass of lithium ion batteries, comprising:
a thermal reactor adapted for receiving the black mass and thermally reducing the black mass to a reduced black mass;
a solid-liquid mixer downstream from the thermal reactor and adapted for receiving the reduced black mass and water;
a solid-liquid separator downstream from the solid-liquid mixer and adapted for (a) receiving the liquid and the reduced black mass from the solid-liquid mixer and (b) separating the liquid from a reduced black mass residual;
an oven downstream from the solid-liquid separator and adapted for receiving and drying the reduced black mass residual received from the solid-liquid separator; and
a magnet-assisted vibration device downstream from the oven and adapted to (i) receive the reduced black mass residual from the oven and (ii) separate magnetic alloy materials in the reduced black mass residual from non-magnetic materials in the reduced black mass residual.

16. The apparatus of claim 15, further including a water supply source connected to the solid-liquid mixer.

17. The apparatus of claim 16, further including a source of reducing agent connected to the thermal reactor.
